(19) United States
(12) Patent Application Publication
(10) Pub. No.: US 2012/0246050 A1
(43) Pub. Date: Sep. 27, 2012

(54) Systems and Methods For Locating the Best Cash Market For a Commodity

(76) Inventor: Kevin Patrick McNew, Bozeman, MT (US)

(21) Appl. No.: 13/053,381

(22) Filed: Mar. 22, 2011

(51) Int. Cl. G06Q 40/00

(52) U.S. Cl. 705/37

(57) ABSTRACT

Systems and methods create a display of commodity purchasers offering the highest net commodity price for a commodity, the net price taking into account the actual transportation and storage costs of the commodity seller for a transaction. In one implementation, the method includes receiving a type of commodity, a storage cost per bushel for the type of commodity, and a transportation cost per bushel for the type of commodity and identifying commodity purchasers for the type of commodity. The method further includes retrieving basis data for the type of commodity for each of the commodity purchasers, the basis data including at least a basis for multiple transaction periods. The method further includes determining distance data between the seller and each of the purchasers, calculating a commodity price for each of the transaction periods for each of the identified commodity purchasers based on the basis data, the distance data, the storage cost, and the transportation cost, and determining which of the purchasers offers the highest commodity price.

### FIELD

This disclosure is generally directed to systems and methods for locating the best market for selling a commodity and, more particularly, to a system and method for determining the commodity purchaser offering the best price for a commodity accounting for storage and transportation costs for the seller.

### BACKGROUND

To maximize profit, farmers desire to sell their crops to the purchasers providing the highest price per bushel for their crops. Commodity purchasers, such as grain elevators or ethanol plants, determine the price they are willing to pay for a bushel of a crop based on a market-set price of the crop. For example, each day the Chicago futures market sets a futures price for a particular crop, which changes throughout the day. A commodity purchaser may offer a basis of −15 cents for a bushel of corn on a given day. A basis is the amount over or under the futures price that a commodity purchaser is willing to pay. Accordingly, a basis of −15 cents results in the commodity purchaser offering to buy corn for 15 cents below the futures price on a given day. If the futures price for corn is $3.00 per bushel, the commodity purchaser will buy corn from farmers for $2.85 per bushel, which is the cash price offered by the purchaser. In addition to offering the basis of −15 cents today, the commodity purchaser may offer a basis of −20 cents for corn purchased a month from now.

Each day commodity purchasers may announce their basis prices for transactions completed the coming day or the next day, and/or for transactions completed in a week, a month, two months, etc. up to a year from today. Farmers looking to sell their crops need to know the basis each purchaser offers to determine which of the purchasers offers the best price for the crops.

In agricultural areas there may be many different commodity purchasers scattered throughout an area surrounding the farmers' locations. Although farmers may know the price that each of the purchasers offers for any particular delivery date, this price does not account for the costs of storage and transportation. Although a purchaser, for example, 200 miles from a farmer offers the best cash price, a purchaser 150 miles from the farmer may offer a better price when difference in transportation costs are accounted for. In addition, the cash price offered three months from now may be higher than the cash price offered today, but not when the additional costs to the farmer of storing the commodity for three months are included.

The vast number of purchasers, the costs of transportation and storage, and the number of transaction periods for which to calculate a net cash price make a true net price comparison difficult. For example, in Iowa there may be over 150 purchasers of corn within a 200 mile radius of a farm. Each purchaser may give a basis for a purchase today, a month into the future, and two, three, and four months into the future, so that a farmer has 750 cash prices to consider. In addition, the transportation costs to each individual purchaser affects the net cash price for each of the 150 purchasers, and the storage costs affect at least 600 of the cash prices. Each of the cash prices can change each day. If the farmer grows more than one type of crop, such calculations must be performed for each crop type, and if the farmer owns more than one farm, transportation costs from each farm must be considered. Storage costs may also differ for each farm. Due to the quantity of information needed to accurately calculate the net price per bushel for each purchaser, for each of the delivery dates, for each type of crop, farmers cannot do such calculations on a daily basis to determine when and where to sell their crops to maximize profit.

Therefore, it is desirable to introduce an apparatus to help farmers quickly and accurately determine the best time and location to sell each of their crops to maximize their profit. It is also desirable to include tools to help the farmer determine whether the prices currently offered are historically strong or historically weak.

### SUMMARY

Disclosed embodiments provide systems and methods that help farmers determine the commodity purchaser offering the best net cash price for a particular crop, given the farmers' transportation and storage costs for the transaction. Disclosed embodiments allow farmers to calculate the best market for multiple farms, and provide information to help the farmer determine the historical strength or weakness of a particular basis offered by a purchaser.

Consistent with disclosed embodiments, a method is provided for determining commodity prices. The method includes receiving commodity sales data for the seller that includes a type of commodity, a storage cost per bushel for the type of commodity, and a transportation cost per bushel for the type of commodity and identifying purchasers that buy the type of commodity purchasers. The method further includes (i) retrieving, from a database, basis data for the type of commodity for each commodity purchasers, the basis data including at least a basis for each of a plurality of transaction periods, (ii) determining distance data that includes a distance between the commodity seller and each of the commodity purchasers, (iii) calculating a commodity price for each of the plurality of transaction periods for each of the identified commodity purchasers based on the basis data, the distance data, the storage cost, and the transportation cost, and (iv) determining, from the identified commodity purchasers a particular commodity purchaser with a highest commodity price.

Consistent with disclosed embodiments, a system is provided for determining commodity prices. The system includes a purchaser database storing basis data for commodity purchasers. The basis data for each commodity purchaser includes a basis for each of a plurality of commodities for each of a plurality of transaction periods. The system also includes a processor and a memory. The memory stores instructions directing the processor to receive a type of commodity, a storage cost per bushel for the type of commodity, and a transportation cost per bushel for the type of commodity. The processor then identifies purchasers that buy the type of commodity and retrieves basis data from the purchaser database for the each of the purchasers. The retrieved basis data includes basis data for the type of commodity obtained by the processor. The processor also determines distance data that may include a driving distance between the commodity seller and each of the identified commodity purchasers. The processor then calculates a commodity price for each of the plurality of transaction periods for each of the identified commodity purchasers. The commodity price is based on the basis data, the distance data, the storage cost, and the transportation cost. The processor then determines, from the identified commodity purchasers, a particular commodity purchaser offering a highest commodity cash price.

Consistent with other disclosed embodiments, computer-readable storage media may store program instructions that are executable by a processor to implement any of the methods, disclosed herein.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a diagram illustrating an exemplary cash market optimizer system that may be used to implement disclosed embodiments;

FIG. 2 is a flow diagram illustrating an exemplary process for locating the best cash market for a commodity, consistent with disclosed embodiments;

FIG. 3 is a flow diagram illustrating an exemplary optimizer process, consistent with disclosed embodiments;

FIG. 4 is a flow diagram illustrating an exemplary process used to calculate a net cash price for each basis for each purchaser, consistent with disclosed embodiments;

FIG. 5 is a flow diagram illustrating an exemplary process used to determine basis strength, consistent with disclosed embodiments;

FIG. 6 depicts an exemplary interface for locating the best cash market for selling a commodity, consistent with disclosed embodiments;

FIG. 7 depicts an exemplary display of details for basis strength for a particular basis for a commodity purchaser, consistent with disclosed embodiments;

FIG. 8 depicts an exemplary interface for obtaining account details for a seller, including multiple seller locations, consistent with disclosed embodiments;

FIG. 9 depicts an exemplary interface for obtaining the latitude and longitude of one or more commodity seller's locations, consistent with disclosed embodiments; and

FIG. 10 is an exemplary flow diagram illustrating a process for creating a database of driving distances, consistent with disclosed embodiments.

### DETAILED DESCRIPTION

A commodity price optimizer offers farmers and other commodity sellers a tool to determine the best time and place (i.e. market) for selling their commodities. The optimizer may be used for any type of commodity, although the examples below use crops for ease of explanation. Those of skill will recognize that the components of the optimizer may be modified to work with other types of commodities as well.

The optimizer system works by collecting data for each commodity buyer, such as location (by zip code and by latitude and longitude) and basis data for various delivery dates for various crops. The basis is collected periodically for crop delivery at a particular date, a month into the future, two months into the future etc. up to twelve months into the future. Embodiments, however, are not limited in the number of months the basis data is collected for, and data may be collected for less than twelve months or for more than twelve months. The basis data may be collected daily, weekly, or some other period. Each period, a basis for delivery now, a month from now, etc. is collected. For example, if the data is collected daily, twelve different basis values may be collected for day 1, with the first value representing crop delivery now, the second value representing crop delivery in a month, etc. and twelve values may also be collected for day 2. The basis data for the various commodity buyers is stored in databases and used to determine the time and place of the best cash market for a particular farmer for a particular crop. An example of the fields in a row of a database table storing the basis data for purchasers is shown below in Table 1:

TABLE 1

| Field Name | Type |
|---|---|
| Purchaser Id | Char |
| Commodity Type | Char |
| Effective Date | Date or Date Range |
| Spot Basis | Number |
| Delivery in 1 Mo. Basis | Number |
| Delivery in 2 Mo. Basis | Number |
| Delivery in 3 Mo. Basis | Number |
| . . . | |
| Delivery in 10 Mo. Basis | Number |
| Delivery in 11 Mo. Basis | Number |

Users of the system, such as farmers, will provide the location of their farm, for example, by zip code or by longitude/latitude. Users may also provide the types of crops for sale, the cost for one month of storage for a bushel of each crop, and the cost to transport one bushel 100 miles. The optimizer system uses this data and the data stored for each purchaser to provide users with an optimal cash market for selling their crop, as well as, optionally, one or more alternatives.

The optimizer system uses the stored data to calculate the net price per bushel all spot prices (sell today) and for all forward deliveries up to one year in the future. For example, even though a farmer may live closest to Market X, Market Y, which is located 100 miles further away, offers a better net price even considering the cost to transport the crop the extra distance and store the crop for two months. A user of the optimizer system may specify storage costs for each crop type so that storage costs accurately reflect the situation for the particular user. Because farmers often deal in hundreds of thousands of bushels of crops at a time, such control over storage costs contributes to the accuracy of the net cash price, and may greatly affect the farmer's actual profits.

To calculate hauling mileage, embodiments of the optimizer may use either a zip code to zip code calculation or a latitude/longitude to latitude/longitude calculation. Using latitude/longitude coordinates may be preferred because this provides a more accurate transportation cost, which can greatly affect the profit of the farmer when selling and transporting hundreds of thousands of bushels of a crop. Current GPS systems may be used to determine latitude/longitude from given addresses for a commodity seller.

The optimizer system also provides an indication of the strength of the basis offered by the purchaser. As described above, the basis is the amount over or under current market price that the purchaser is willing to pay. Normally, the basis changes every day for every purchaser. The optimizer system determines the strength of the basis by comparing the basis to historical values for the basis for the same purchaser. A basis that is low compared with what the purchaser has historically offered indicates that the basis is weak. A basis that is high compared with what the purchaser has historically offered is strong. The basis indicator further helps the farmer determine whether to sell now or wait for the purchasers to offer a better basis.

Reference will now be made in detail to exemplary embodiments, examples of which are illustrated in the accompanying drawings. Wherever convenient, the same reference numbers will be used throughout the drawings to refer to the same or like parts.

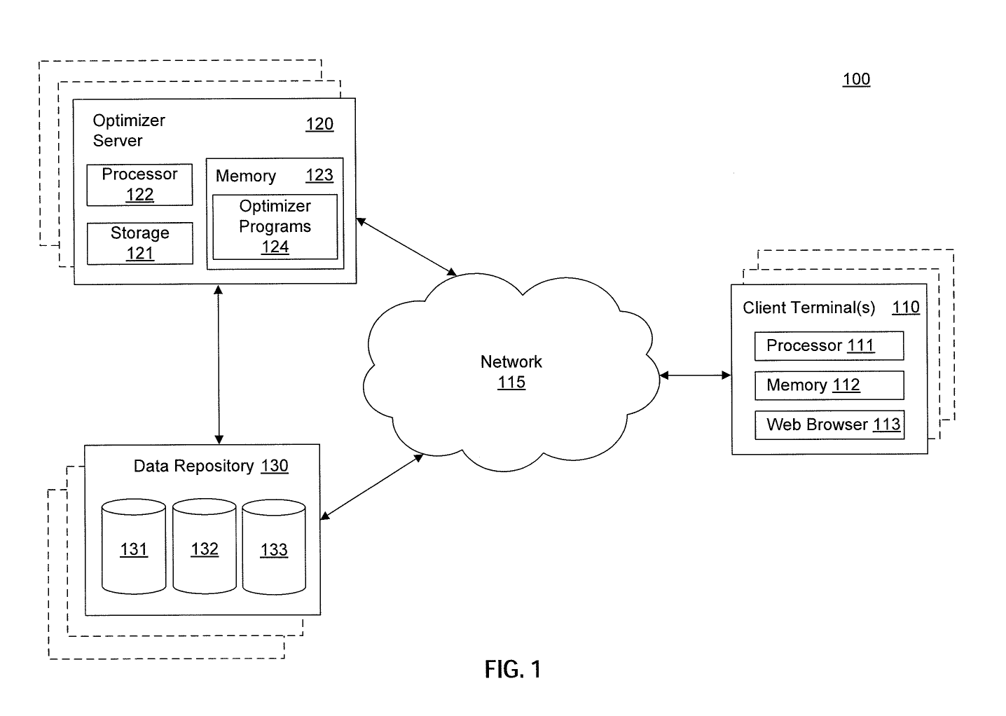

FIG. 1 is a diagram illustrating an exemplary net cash price optimizer system that may be used to implement disclosed embodiments, including exemplary system components. The components and arrangement, however, may be varied.

Optimizer server 120 may include a processor 122, a memory 123, input/output (I/O) devices (not shown), and a nonvolatile storage 121. Optimizer server 120 may be implemented in various ways. Optimizer server 120 may be a general purpose computer, a server, a mainframe computer, or any combination of these components. Optimizer server 120 may communicate over a link with network 115. For example, the link may be a direct communication link, a LAN, a WAN, or other suitable connection. Optimizer server 120 may be standalone or it may be part of a subsystem, which may, in turn, be part of a larger system, such as a legacy commodity tracking system.

Processor 122 may be one or more known processing devices, such as a microprocessor from the Core™ family manufactured by Intel Corporation or the Optcion™ family manufactured by Advanced Micro Devices, Inc. Memory 123 may be one or more storage devices configured to store information used by processor 122 to perform certain functions related to disclosed embodiments. Storage 121 may be a volatile or non-volatile, magnetic, semiconductor, tape, optical, removable, nonremovable, or other type of storage device or computer-readable medium. In one embodiment, memory 123 may include one or more programs or subprograms 124 loaded from storage 121 or elsewhere that, when executed by processor 122 of server 120, perform various optimization procedures, operations, or processes consistent with disclosed embodiments. For example, memory 123 may include a net cash price determination program that determines purchasers within a given area of a seller's location, gathers basis data for the purchasers and uses the basis data and location data for the seller's location and the purchaser to determine the net price for each delivery date for each purchaser. Memory 123 may also include a driving distance calculation program that calculates the driving distance between a farm and various purchasers within a given area using the latitude and longitude locations of the farm and the purchaser and stores the data in a database, a best cash market display program that creates data used to display the basis and net price data for various purchasers of a particular crop, an account settings program that obtains account defaults for a particular user and allows a user to identify their farm location, and an integrative support program that links the other programs and allows them to use a common database, provides a common user interface, performs basic bookkeeping tasks, (such as storing the user's input, etc.), and provides user guidance and help. Memory 123 may also include other programs that perform other functions and processes, such as programs that provide communication support, Internet access, etc.

Methods, systems, and articles of manufacture consistent with disclosed embodiments are not limited to separate programs or computers configured to perform dedicated tasks. For example, memory 123 may be configured with an optimizer program 124 that performs several functions when executed by processor 122. For example, memory 123 may include a single program 124 that performs the functions of the optimizer system, or program 124 could comprise multiple programs. Moreover, processor 122 may execute one or more programs located remotely from optimizer server 120. For example, optimizer server 120 may access one or more remote programs that, when executed, perform functions related to disclosed embodiments.

Memory 123 may be also be configured with an operating system (not shown) that performs several functions well known in the art when executed by optimizer server 120. By way of example, the operating system may be Microsoft Windows™, Unix™, Linux™, Solaris™, or some other operating system.

Optimizer server 120 may include one or more I/O devices (not shown) that allow data to be received and/or transmitted by optimizer server 120. I/O devices may also include one or more digital and/or analog communication input/output devices that allow optimizer server 120 to communicate with other machines and devices. Optimizer server 120 may receive data from external machines and devices and output data to external machines and devices via I/O devices. The configuration and number of input and/or output devices incorporated in I/O devices may vary as appropriate for certain embodiments.

Optimizer server 120 may also be communicatively connected to one or more data repositories 130 through network 115. Data repository 130 may include one or more databases 131-133 that store information and are accessed and/or managed through optimizer server 120. By way of example, the databases may be Oracle™ databases, Sybase™ databases, Hadoop sequence files, or other databases. The databases may include, for example, data and information related to commodity purchasers, current and historical basis data for the various commodity purchasers, driving distances between zip codes, driving distances between a user's latitude/longitude location and the latitude/longitude for each commodity purchaser, account settings for a user of the optimizer system, distance data for a plurality of farms for a user of the optimizer system, etc. Systems and methods of disclosed embodiments, however, are not limited to separate databases or any particular data storage configuration.

Optimizer server 120 may also be communicatively connected to one or more data client terminals 110 through network 115. Client terminal 110 may include a processor 111, a memory 112, and a web browser 113 that enable it to communicate with optimizer server 120. Optimizer server 120 may send data to processor 111 and web browser 113, and web browser 113 may display the data as the results of a cash market analysis. In some embodiments, optimizer server 120 may render the results of a cash market analysis and send the results to web browser 113 for display. In other embodiments, optimizer server 120 may send the data used to create the cash market analysis results to client terminal 110 and client terminal 110 may render the results of the cash market analysis. Client terminal 110 may include a smartphone, a tablet computer, a personal computer, or any other personal or portable computing device.

Client terminal 110 may in turn send data to optimizer server 120 indicating selection of farm data, crop type, transportation cost, storage cost, transaction period parameters, etc. Client terminal 110 may also send requests to optimizer server 120. Client terminal 110 may include I/O devices (not shown) to enable communication with a user, such as a farmer. For example, the I/O devices may include one or more input devices, such as a keyboard, touch screen, mouse, and the like, that enable client terminal 110 to receive data from a user, such as crop parameters, farm locations, search requests, etc. Further, client terminal 110 may include I/O devices that communicate with one or more output devices, such as a display screen, CRT monitor, LCD monitor, plasma display, printer, speaker devices, and the like, that enable client terminal 110 to present data to a user.

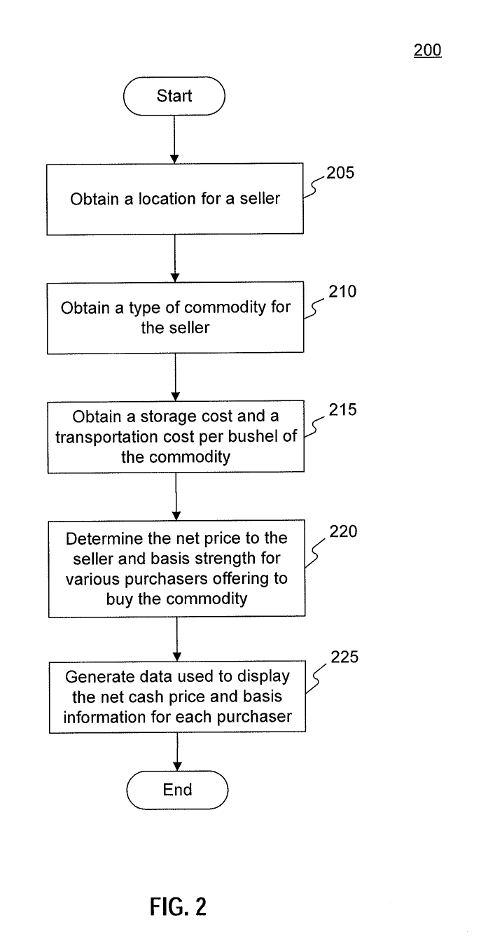

FIG. 2 is a flow diagram illustrating an exemplary process for locating the best cash market for a commodity, consistent with disclosed embodiments. This process is a high level view of how a commodity seller, such as a farmer, may use the optimizer tool to obtain the optimal time and place to sell various commodities. In certain embodiments, process 200 may be implemented according to optimizer program 124.

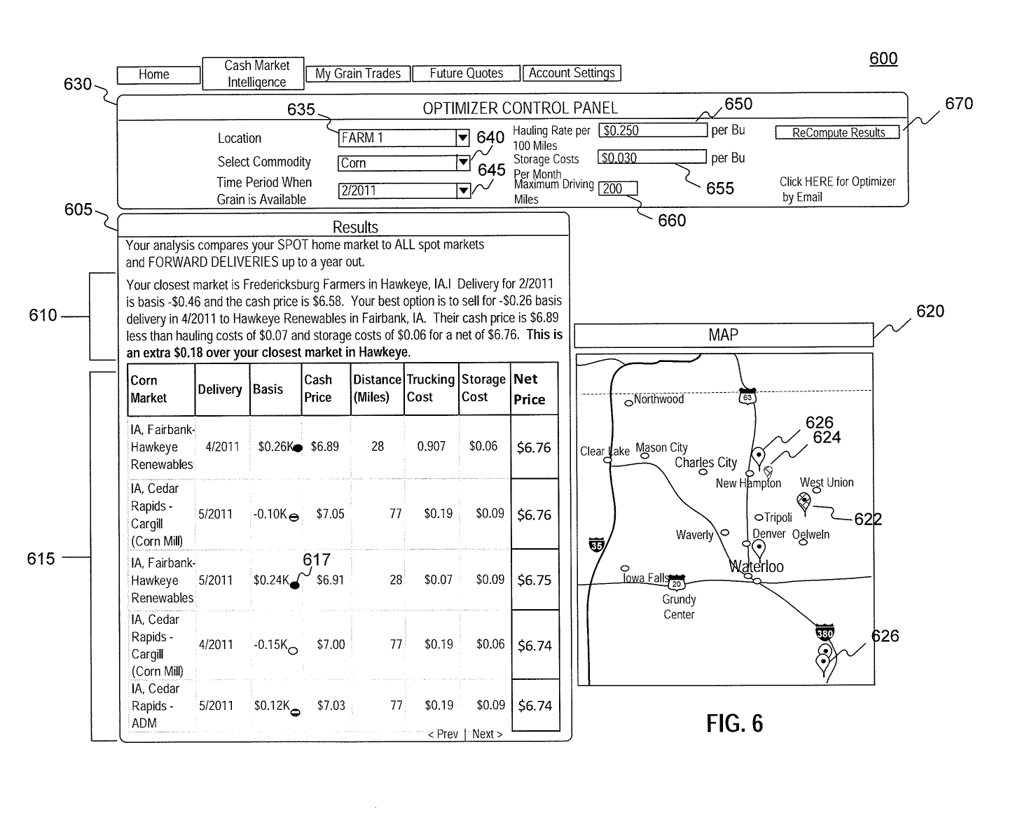

At Step 205, optimizer server 120 obtains location data for the seller. For example, optimizer server 120 may receive login information for a user and authenticate the user according to methods known in the art. As a result of a login, optimizer server 120 may retrieve account information for the seller, for example, from data repository 130. The account information may include a plurality of farm locations, a plurality of crops, storage costs for the crops, and various other data regarding the seller. Optimizer server 120 may choose one of the farm locations as a default location. Alternatively, optimizer server 120 may obtain a selection of one of the farm locations from the user through a user interface, such as the interface discussed below with regard to FIG. 6. In some embodiments, optimizer server 120 may obtain the location data directly from user input by, for example, accepting a zip code or latitude/longitude coordinates.

At Step 210, optimizer server 120 obtains a type of commodity for the seller. As discussed above, the type of commodity may be based upon account information retrieved by optimizer server 120. Alternatively, optimizer server 120 may obtain the type of commodity from selection of a commodity by the user through use of a user interface. In some embodiments, optimizer server 120 may obtain a default commodity type from account settings and may allow the user to change the commodity type through a user interface. At Step 215, optimizer server 120 obtains a per-bushel storage cost and a per-bushel transportation cost for the selected commodity. Optimizer server 120 may obtain the storage and transportation costs from user account data stored in data repository 130. Alternatively, the user may supply the storage and transportation costs using a user interface. In some embodiments, optimizer server 120 may retrieve the storage and transportation costs from user account data and provide the user with an opportunity to modify the data retrieved from storage.

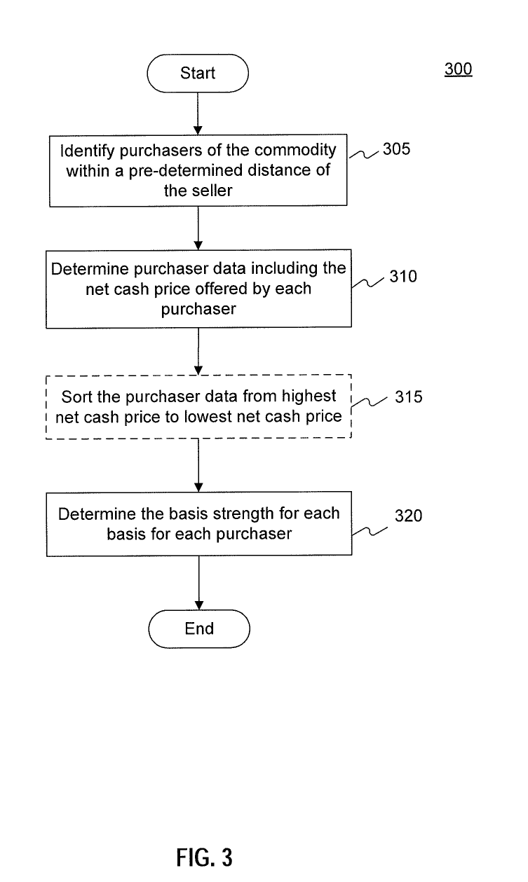

At Step 220, optimizer server 120 determines the net price to the seller for various purchasers who buy the commodity. This process is discussed in more detail below with regard to FIG. 3. At Step 225, optimizer server 120 may generate data used to display the net cash price results. As described above, optimizer server 120 may render a display of the data, such as that shown in FIG. 6, or processor 111 at client terminal 110 may receive data from server 120 to render the display.

FIG. 3 is a flow diagram illustrating an exemplary optimizer process 300, consistent with disclosed embodiments. Process 300 reflects operations by optimizer server 120 to determine the purchaser offering the highest net price for a commodity to the seller. In certain embodiments, process 300 may be implemented according to optimizer program 124 as part of Step 220 of FIG. 2.

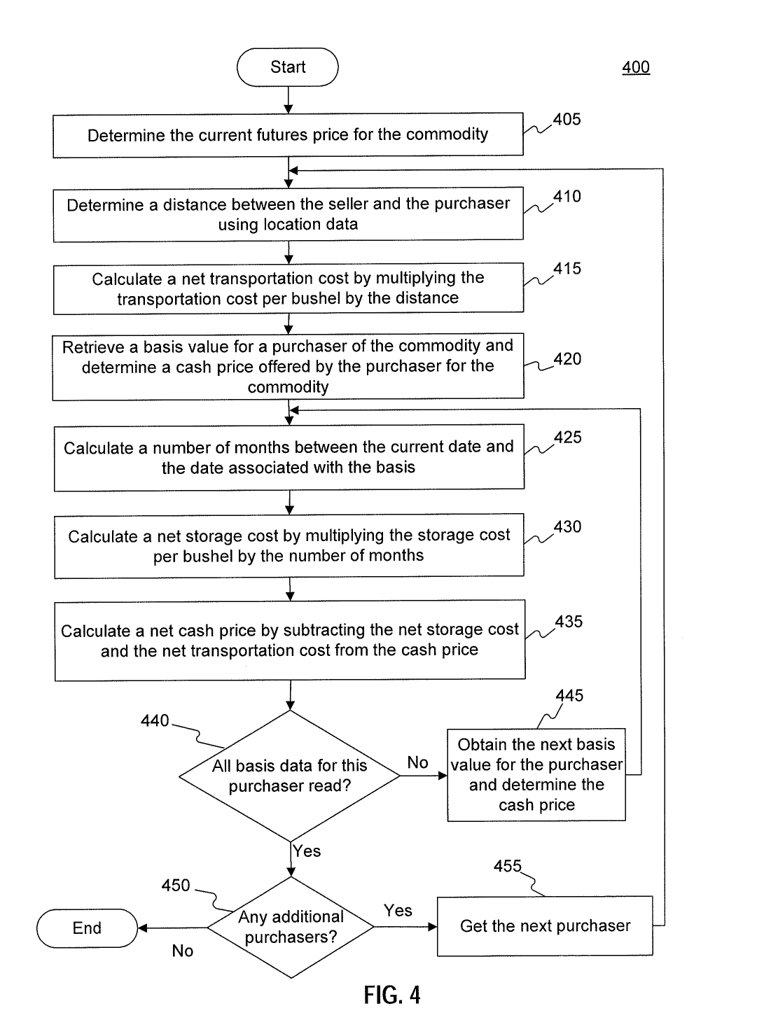

In Step 305 of FIG. 3, optimizer server 120 identifies purchasers of the type of commodity. For example, data repository 130 may store the types of commodities each purchaser buys and optimizer server 120 may retrieve the purchasers from data repository 130. In some embodiments, optimizer server 120 may select only purchasers located within some pre-determined distance from the seller as part of Step 305. At Step 310, optimizer server 120 calculates a net cash price for each purchaser for various transaction periods. For example, a purchaser may offer to buy corn for one price today (spot), for a different price a month from now, and for a still different price four months from now. Optimizer server 120 may calculate a net price for the three transaction periods for the purchaser. This process is described in more detail below with regard to FIG. 4.

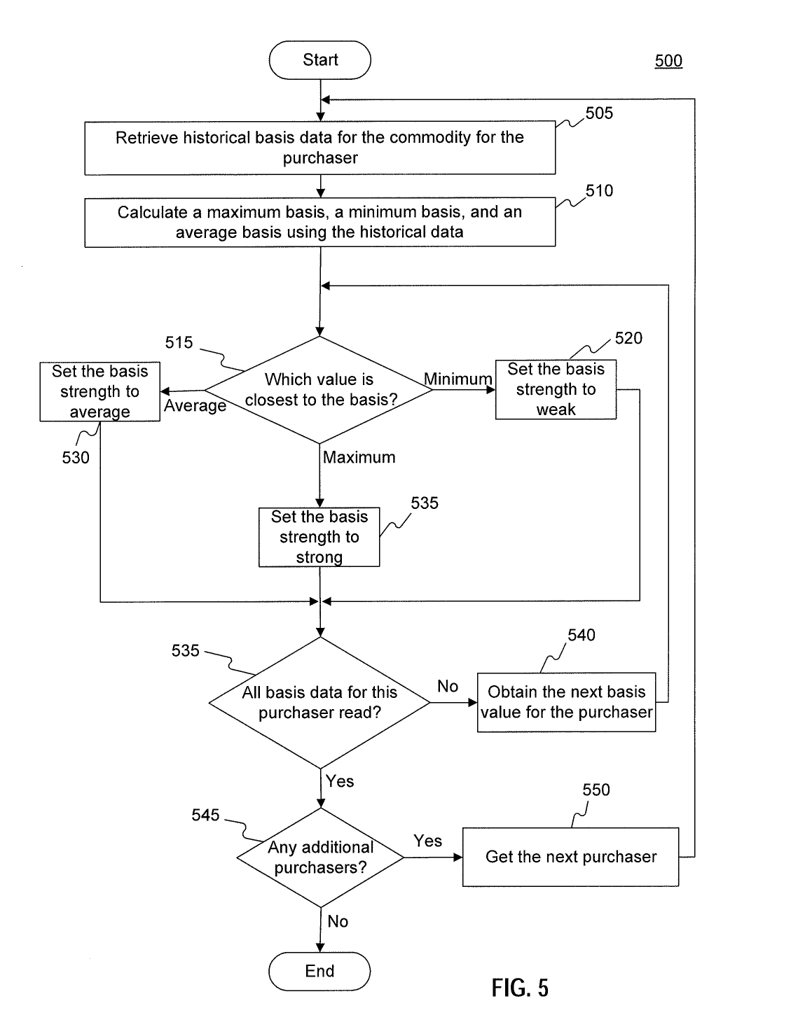

In Step 315, optimizer server 120 optionally sorts the net price data from highest net cash price to lowest net cash price, so that optimizer server 120 may display the highest net prices to the user first, with the nearest transaction dates sorted before later transaction dates within the same net price. However, embodiments are not limited to the sort order of the net price data and embodiments encompass other sort orders, such as distance between the seller and the purchaser. At Step 320, optimizer server 120 calculates a basis strength for each basis for each purchaser for various transaction periods. Optimizer server 120 may incorporate the basis strength into the results of the net cash price data, providing the user with information the user can use to determine whether the net cash price is weak. If the price is weak, the user may consider waiting to sell the commodity to receive a stronger (i.e. higher) basis. The determination of basis strength is described in additional detail below with regard to FIG. 5.

FIG. 4 is a flow diagram illustrating an exemplary process 400 used to calculate a net cash price for each basis for each purchaser, consistent with disclosed embodiments. The process 400 of FIG. 4 may be used during the calculation of a net cash price for each basis for each purchaser, as described in step 310 of FIG. 3.

In Step 405, optimizer server 120 determines the current futures price for the selected commodity type. The futures price may be determined by a futures exchange, such as the futures exchange based in Chicago, Ill., and changes constantly, similar to stock prices on the stock market. Optimizer server 120 may obtain a most recent futures price for a commodity in real-time, or every 5 minutes, every 20 minutes, etc. from a futures exchange using known methods. The futures price provides a base from which the optimizer server 120 can calculate a cash price for the commodity.

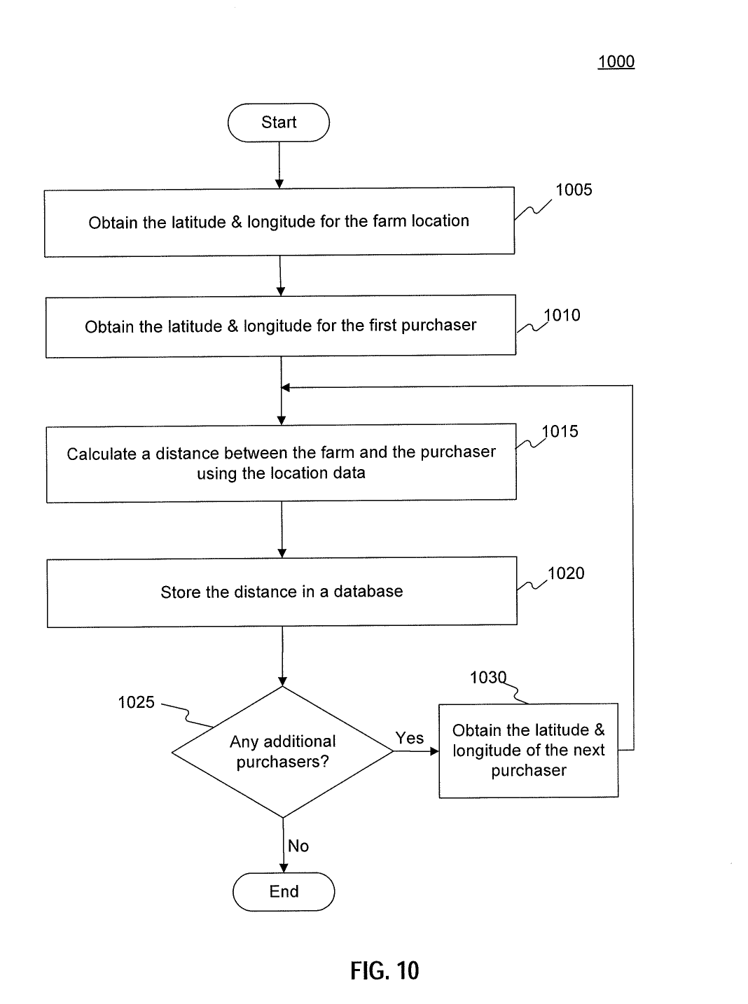

At Step 410, optimizer server 120 determines the driving distance between the seller and the purchaser using location data for the seller and the purchaser. When location data includes a zip code associated with the seller and the purchaser, optimizer server 120 may retrieve the driving distance from a database storing the driving distance between zip codes. When location data includes the latitude/longitude of the seller and the purchaser, optimizer server 120 may calculate the driving distance using the latitude/longitude values, or may retrieve the driving distance from a database storing the pre-calculated driving distance, as described in more detail below with regard to FIG. 10.

In some embodiments, optimizer server 120 may compare the driving distance with a pre-determined value. If optimizer server 120 determines that the driving distance is farther (i.e. higher) than a pre-determined value, then optimizer server 120 may skip the purchaser and process the next purchaser, as at step 455. In this manner, optimizer 120 may only determine the net cash price for purchasers within a pre-determined driving distance from the seller. In other embodiments, optimizer server 120 may eliminate purchasers further than a pre-determined distance as part of process 305 of FIG. 3, removing these purchasers before proceeding to Step 310.

At Step 415, optimizer server 120 calculates a net transportation cost for the commodity by performing a calculation that involves multiplying the transportation cost per bushel by the distance between the seller and the purchaser. This net transportation cost is calculated on a per-bushel basis.

At Step 420, optimizer server 120 retrieves a spot basis value for the purchaser for the commodity for a currently effective date and determine a cash price for the commodity by adding the basis to the futures price determined in Step 405. Data repository 130 may contain basis data for each purchaser. For example, for any given effective date, data repository may store the purchaser's basis for corn for delivery today (i.e. spot), for delivery next month, for delivery in two months, etc. up to twelve months. This may be repeated for soybeans, wheat, or any other commodity purchased by the purchaser. Thus, for each effective date, data repository 130 may contain twelve basis values for each commodity. In some embodiments the basis data may be effective for a specified time frame, such as two days, or one week, rather than for a specific date. Optimizer server 120 may select the spot basis value first, and then process each additional basis value for the effective date. Optimizer server 120 may then calculate a cash price by adding the basis to the futures price.

In some embodiments, the user may supply a delivery date and optimizer server 120 may select basis values associated with deliveries occurring after that date. For example, the user may select a date two months from now. In this example, optimizer server 120 may select the basis value for two months from now first because the spot basis value occurs prior to the user's specified delivery date. As described above, optimizer server 120 may then calculate the cash price by adding the selected basis value to the futures price.

At Step 425, optimizer server 120 calculates a number of months between the current date and the date associated with a particular basis value. For example, if the basis value were for spot (delivery today), optimizer server 120 would calculate zero months. If the basis value were for a date two months from now, optimizer server 120 would calculate two months. At Step 430, optimizer server 120 calculates a net storage cost by multiplying the number of months by the storage cost per bushel for the seller. As described above, optimizer server 120 may obtain the storage costs through a user interface or through default account settings.

At Step 435, optimizer server 120 calculates a net cash price for the date associated with the basis value by subtracting the net storage cost and the net transportation costs from the cash price. Optimizer server 120 may retain this net cash price and the data used to calculate it in, for example, memory 123 or storage 121.

Next, at Step 440, optimizer server 120 determines whether all basis data has been processed for this purchaser. For example, if optimizer server 120 has only read the spot basis for this purchaser, not all basis data has been processed. If not all basis data has been processed (Step 440, No), then in Step 445, optimizer server 120 retrieves the next basis value for the effective date, calculates the cash price by adding the next basis value to the futures value, and proceeds to Step 425 with the next basis value and the calculated cash price.

If, however, optimizer server 120 has finished reading all basis values for the effective date for the purchaser (Step 440, Yes), then in Step 450, optimizer server 120 determines if any additional purchasers of the commodity exist. If there are additional purchasers to process (Step 450, Yes), then at Step 455, optimizer server 120 gets the next purchaser and proceed to Step 410. If all purchasers for the commodity have been processed (Step 450, No), then optimizer server 120 has concluded process 400 and returns to process 220 with the net cash price data it has calculated.

In some embodiments, optimizer server 120 may add a basis strength to the net cash price data it has calculated. FIG. 5 is an exemplary flow diagram illustrating an exemplary process 500 used to determine basis strength, consistent with disclosed embodiments. Optimizer server 120 may perform process 500 as part of Step 320, once optimizer server 120 has determined the net cash data for the purchasers. In other embodiments, optimizer server 120 may perform process 500 as part of process 400, shown in FIG. 4, at a point between Steps 425 and 440.

At Step 505, optimizer server 120 retrieves historical basis data for the commodity for a particular purchaser. Historical basis values are basis values for effective dates that have passed. As described above, basis values may be stored by effective date and may be kept indefinitely or kept for some period of time, such as five years. Optimizer server 120 may read the historical basis data going back, for example, one year, three years, or five years. In some embodiments, the time period may be based on the amount of historical data stored for a particular purchaser. For example, purchaser A may only have a year and a half of historical basis data but purchaser B may have five years available. Optimizer server 120 may use a period of one year for purchaser A and five years for purchaser B.

Next, in Step 510, optimizer server 120 calculates a maximum basis, a minimum basis and an average basis from the historical basis data. In some embodiments, a mean basis may be used instead of or in addition to an average basis. The maximum, minimum, and average may be based on data extending back one, three, or five years from the effective date of the basis value being rated. Next, in Step 515, optimizer server 120 determines which of the three values the basis being rated is closest to. If the current basis is closest to the minimum basis (Step 515, Minimum), then in Step 520, optimizer server 120 sets the basis strength for the current basis to weak. If the current basis is closest to the maximum value (Step 515, Maximum), then in Step 525, optimizer server 120 sets the basis strength for the current basis to strong. If the current basis is closest to the average (or mean) value (Step 515, Average), then in Step 530, optimizer server 120 sets the basis strength for the current basis to average.

After determining the basis strength for the basis being rated, optimizer server 120 may determine if there are any other basis values for this purchaser to process. As described above with regard to FIG. 4, each purchaser may have twelve basis values to process. If there are more basis values (Step 535, No), then at Step 540, optimizer server 140 reads the next basis value for the purchaser and proceeds to Step 510 with the next basis value being evaluated for basis strength. If all basis values have been processed for this purchaser (Step 535, Yes), then optimizer server 120 determines if there are additional purchasers to process. If there are additional processors (Step 545, Yes), then at Step 550, optimizer server 120 retrieves the next purchaser and proceeds to Step 505 with the next purchaser. Process 500 continues until optimizer server 120 has processed all purchasers.

As described above, process 500 may be performed independently of process 400 (as shown), or may be combined with process 400, such that Steps 505 through 530 are performed at a point between steps 425 and 440. In either case, optimizer server 120 may combine the basis strength determined by process 500 with the net cash price data obtained through process 400.

FIG. 6 depicts an exemplary interface 600 for displaying net cash price data for various purchasers and for receiving various parameters, consistent with disclosed embodiments. Optimization server 120 may display the net cash price data obtained through processes 400 and 500 in a display such as results display 605. Results display 605 may contain text summary 610. Text summary 610 may include a description of the net price for the purchaser closest to the seller, a description of the best option for selling the commodity (i.e. the purchaser location and date having the highest net cash price), and a description of the extra profit per bushel offered by the best option compared with the closest purchaser.

In addition to text summary 610, optimizer server 120 may provide a tabular display 615 of the various selling opportunities available to the commodity seller as part of results display 605. For example, optimizer server 120 may have sorted the net cash price data from process 400 by descending net price and delivery date. Optimizer server 120 may then show each selling opportunity (e.g. by purchaser and date) as a row in table 615. In some embodiments, tabular display 615 may include a basis strength indicator 617. The basis strength indicator 617 is a visual indication of the strength of the basis in the row of display 625. As previously described, a basis may be considered strong, average, or weak.

FIG. 6 also shows indicator 617 as an icon with different shading to reflect the strength of the basis. For example, the icon for a strong basis may be shaded green, the icon for an average basis may be may shaded yellow, and the icon for a weak basis may be shaded red. Those of skill in the art will recognize that any type of shading, color scheme, or icon shape may be used to indicate the basis strength. In addition to an icon, tabular display 615 may include highlighting of the row or displaying the basis (e.g. $0.24K) in a different color depending on the basis strength. The implementation of indicator 617 is not important so long as it provides an indication of the basis strength for a row in table 615.

Interface 600 may also include map 620. Map 620 may include an indication 622 of the location of the seller. In some embodiments, map 620 may also include an indication 624 of an alternative location of the seller, such as a second farm. The location used to calculate the net cash prices shown in table 615 may be marked with indication 622, with any other farms owned by the same seller marked with indication 624. Indication 624 may be smaller or differently colored than indication 622. Map 620 may also use indicators 626 to mark the locations of the purchasers having data in table 615. Optimizer server 120 may allow the user to zoom and pan map 620 using methods known in the art.

Interface 600 may also include control panel 630. Optimizer server 120 may use control panel 630 to interface with and receive input from a user. For example, optimizer server 120 may receive a location selection from the user through location selector 635. Location selector 635 may be a drop-down box listing the various farm locations associated with the user. Changing a location affects the transportation costs used to determine the net prices shown in table 615. A user may change the location used to determine the data shown in results window 605 by selecting a location from location selector 635 and then selecting button 670, for example. Optimization server 120 may also receive the type of commodity from commodity selector 640. For example, farmers may grow more than one type of crop and may need to determine the best market for each crop independently. Additionally, storage and transportation costs may be different for each type of crop. Accordingly, in some embodiments, when optimization server 120 receives a change of commodity type through commodity selector 640, optimization server 120 may change the hauling rate 650 and the storage costs 655 by reading values stored in the account data for the user.

Interface may also include transaction period selector 645. A farmer may not have any crops ready for delivery until three months from now. Accordingly, the farmer may want to exclude any basis values for delivery dates occurring before that time. When optimization server 120 receives a date from transaction period selector 645, it may exclude any basis values associated with delivery dates before the date selected in the transaction period selector 645 from the data used to create results window 605.

Interface 600 may also include transportation cost selector 650. An initial value for transportation cost selector 650 may be stored for each commodity type in account data for the user. Optimization server 120 may read the transportation cost from the account data and populate transportation cost selector 650 with this information after an initial log-in by the user. In some embodiments, the user may desire to change the transportation costs to perform “what-if” scenarios. Accordingly, optimization server 120 may receive a change to the transportation costs through transportation cost selector 650 and use the new value to calculate the net prices shown in results window 605. Although shown as a rate per 100 miles in FIG. 6, embodiments are not limited to this rate and may encompass any rate that can be used to calculate the costs to a seller of transporting a commodity over a distance.

Likewise, interface 600 may include a storage cost selector 655. Optimizer server 120 may obtain an initial storage value for a commodity type from account data stored for the user. In addition, the user may modify the storage cost using storage cost selector 655. In this manner, optimizer server 120 offers the user an avenue to discretely control the storage costs, resulting in an accurate net price calculation for the particular user. Finally, optimizer server 120 may allow a user to specify a maximum driving distance using mileage selector 660. A farmer may not be willing to travel long distances to sell commodities, no matter how much more the purchaser offers per bushel. Mileage selector 660 allows the farmer to specify a mileage, so that optimizer server 120 may only calculate the net cash price for purchasers located within the driving distance represented by the value entered in mileage selector 660.

Through interface 600, optimizer server 120 may allow the user to control the amount of data displayed in results window 605. Optimizer server 120 may use the values entered by the user in selectors 635-645 and 660 to determine which purchasers and basis values can be excluded from the net price calculations. Optimizer server 120 also allows the user to perform “what-if” scenarios through modification of transportation and storage costs using selectors 650 and 655. Thus, optimizer server 120 offers a flexible yet powerful tool for assisting farmers in determining when and where to sell their crops.

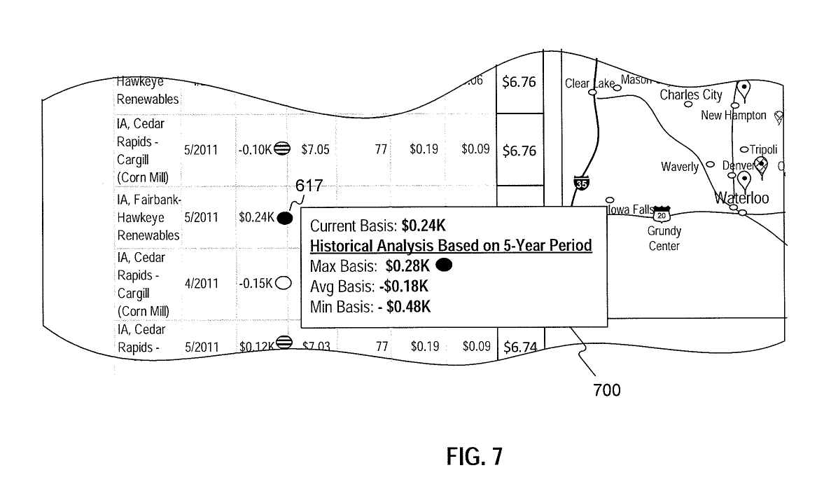

FIG. 7 depicts an exemplary window 700 with details for basis strength for a particular basis for a purchaser, consistent with disclosed embodiments. Optimizer server 120 may cause window 700 to appear when a user selects indicator 617 by, for example, clicking on indicator 617. In other embodiments, optimizer server 120 may cause window 700 to appear when a user “rolls-over” indicator 617. A “roll-over” occurs when the user places a mouse cursor over the top of indicator 617 but does not require that the user select (e.g. click on) indicator 617.

Window 700 may include information used to determine whether the basis is strong, average, weak. For example, window 700 may include the period of time for which basis data was analyzed, the maximum basis during the time period, the average basis during the time period, and the minimum basis during the time period. This information provides users with the ability to judge the strength of the basis themselves. For example, some users may not rely on a basis strength for one year worth of basis data and may disregard indicator 617 when its value is based on a one year period.

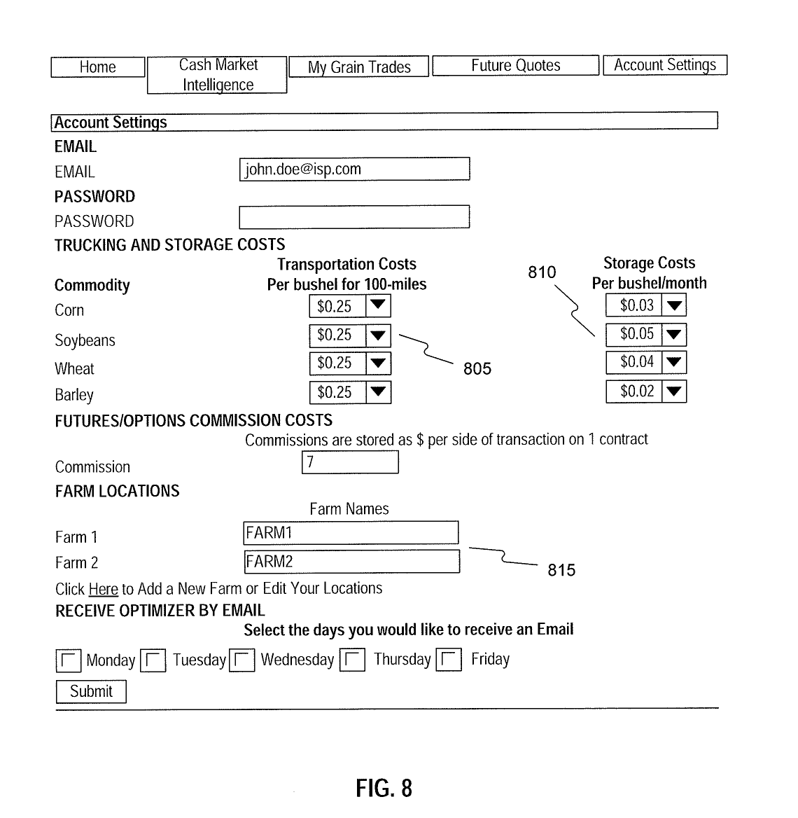

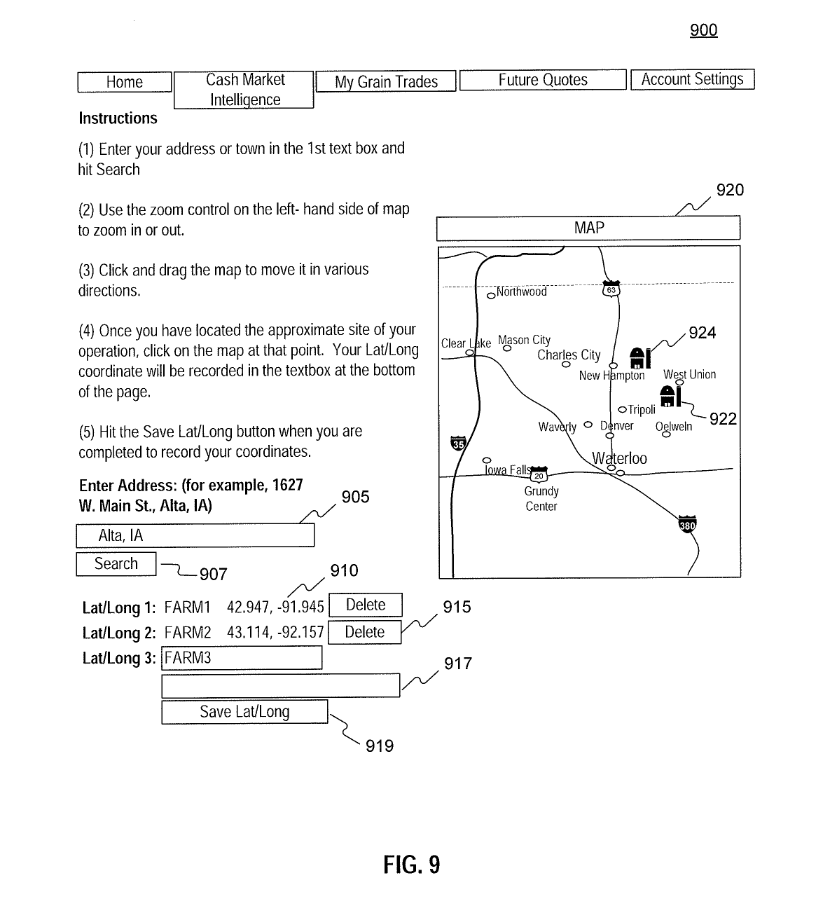

FIG. 8 depicts an exemplary interface for obtaining account details for a user of an optimizer system. Such details may include, for example, various farm locations. User account data may also include default transportation costs per bushel 805 and default storage costs per bushel 810 for each type of commodity. Optimizer server 120 may retrieve these values when performing process 400 to create an initial display of interface 600 for a user. A user account may also include a plurality of farm locations 815. Each farm location may have different location data associated with it, as shown in FIG. 9.

FIG. 9 is an exemplary interface for obtaining the latitude and longitude of a commodity seller's location, such as a farm location, consistent with disclosed embodiments. Optimizer server 120 may use an interface, such as interface 900 shown in FIG. 9 to obtain location data for a farm, to add additional farms to a user's account, and to remove a farm from a user's account. A user may use text box 905 to cause map 920 to scroll to the location of the user's farm. The user may enter a city and state or a street address into text box 905 and select search icon 907. This may cause map 920 to pan so that the address in text box 905 appears in the center of the map. The user may then click on the map. When the user clicks on the map, text box 917 may receive the latitude and longitude coordinates of the location clicked. The latitude and longitude coordinates of the farm may be added to the user account data through save icon 919. Map 920 may also display icons 924 and 922 representing the location of previously saved farms.

Interface 900 may also include the latitude and longitude coordinates of farms already associated with the user account data, as shown by coordinates 910. If a user desires to delete a farm location, this may be accomplished using delete icon 915. Seller location data and user account data may be stored, for example, in storage 121 or data repository 130. Although FIG. 9 identifies farm locations, embodiments are not limited to farms, but encompass any location owned by a commodity seller, including warehouses and other storage locations.

For each location associated with a user account, optimizer server 120 may calculate and store the driving distance between the location and each commodity purchaser within a pre-determined area of the location. FIG. 10 depicts an exemplary flowchart illustrating a process 1000 for creating a database of driving distances, consistent with disclosed embodiments. Optimizer server 120 may execute process 1000 after a user selects a new seller location by, for example, selecting icon 919 of FIG. 9. In other embodiments, optimizer server 120 may execute process 1000 at a regularly scheduled time, such as nightly, for any locations added since the previous execution. In yet other embodiments, optimizer server 120 may execute a process similar to process 1000 that adds a driving distance record to each seller location within a pre-determined area of a newly added purchaser.

At Step 1005, optimizer server 120 obtains the latitude and longitude coordinates for a seller's location, such as a farm. In Step 1010, optimizer server 120 obtains the latitude and longitude coordinates for a purchaser within a pre-defined area.

A pre-defined area may include purchasers in the same state as the farm, purchasers in zip-codes that are within 500 miles of the farm, or some other calculation. At Step 1015, optimizer server 120 calculates a driving distance between the farm and the purchaser using the latitude and longitude coordinates. The driving distance may be calculated using any of several known algorithms. Next, at Step 1020, optimizer server 120 stores the driving distance in a database associated with the farm, the purchaser, and the user of the account.

At Step 1025, optimizer server 120 determines whether any remaining purchaser locations need to be processed. If so (Step 1025, Yes), then at Step 1030, optimizer server 120 obtains the location data for the next purchaser and proceeds to Step 1015. If no purchaser locations need to be processed (Step 1025, No), process 1000 ends. The data gathered and stored by process 1000 may allow optimizer server 120 to more quickly generate the data needed to create display 600. Because driving distance calculations using latitude and longitude coordinates can be cumbersome, optimizer server 120 may use the data created by process 100 to avoid having to do several hundred such calculations to produce accurate transportation costs used to calculate the net prices shown in display 600.

The foregoing descriptions have been presented for purposes of illustration and description. They are not exhaustive and do not limit the disclosed embodiments to the precise form disclosed. Modifications and variations are possible in light of the above teachings or may be acquired from practicing the disclosed embodiments. For example, the described implementation includes software, but the disclosed embodiments may be implemented as a combination of hardware and software. Examples of hardware include computing or processing systems, including personal computers, servers, laptops, tablet computers, smart phones, mainframes, micro-processors, and the like. Additionally, although disclosed aspects are described as being stored in a memory on a computer, one skilled in the art will appreciate that these aspects can also be stored on other types of computer-readable media, such as secondary storage devices, like hard disks, floppy disks, a CD-ROM, USB media, DVD, RAM or ROM, and other forms of physical computer storage devices.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), XML, Java, C++, JavaScript, HTML, HTML/AJAX, Flex, Silverlight, or any other now known or later created programming language. One or more of such software sections or modules can be integrated into a computer system or existing browser software.

Other embodiments will be apparent to those skilled in the art from consideration of the specification and practice of the embodiments disclosed herein. The recitations in the claims are to be interpreted broadly based on the language employed in the claims and not limited to examples described in the present specification or during the prosecution of the application, which examples are to be construed non-exclusive. Further, the steps of the disclosed methods may be modified in any manner, including by reordering steps and/or inserting or deleting steps. It is intended, therefore, that the specification and examples be considered as exemplary only, with a true scope and spirit being indicated by the following claims and their full scope equivalents.

What is claimed is:

1. A computer-implemented method for determining commodity prices, comprising:
receiving commodity sales data including a type of commodity, a storage cost per bushel for the type of commodity, and a transportation cost per bushel for the type of commodity for a commodity seller;
identifying, by a processor, a plurality of commodity purchasers for the type of commodity;
retrieving from a database basis data for the type of commodity for each of the identified commodity purchasers, the basis data including at least a basis for each of a plurality of transaction periods;
determining distance data including a distance between the commodity seller and each of the identified commodity purchasers;
calculating, by the processor, a commodity price for each of the plurality of transaction periods for each of the identified commodity purchasers based on the basis data, the distance data, the storage cost, and the transportation cost; and
determining, from the identified commodity purchasers, a particular commodity purchaser with a highest commodity price.

2. The method of claim 1, wherein determining the distance data includes retrieving, from a database, a driving distance between the commodity seller and each of the identified commodity purchasers, the driving distance calculated using latitude and longitude coordinates.

3. The method of claim 1, further comprising:
generating data used to display the commodity price for each of the plurality of transaction periods for each of the identified commodity purchasers; and
generating data used to display a difference between the highest commodity price and a commodity price for a purchaser located closest to the commodity seller.

4. The method of claim 1, further comprising:
for each of the identified commodity purchasers, determining a strength of the basis associated with each transaction period; and
generating data used to display the strength of the basis.

5. The method of claim 4, wherein the data used to display the strength of each basis includes a green icon for a strong basis and a red icon for a weak basis.

6. The method of claim 1, wherein receiving the commodity sales data includes retrieving the storage cost per bushel from a database record associated with the commodity seller.

7. The method of claim 1, wherein receiving the commodity sales data includes receiving the storage cost per bushel through a user interface.

8. The method of claim 1, wherein the commodity sales data includes a location for the commodity seller chosen from a plurality of locations associated with the commodity seller and the distance data includes a distance between the chosen location and each of the identified commodity purchasers.

9. A computer-readable storage media storing instructions for determining commodity prices, the instructions causing one or more computer processors to perform operations, comprising:
receiving commodity sales data including a type of commodity, a storage cost per bushel for the type of commodity, and a transportation cost per bushel for the type of commodity for a commodity seller;
identifying a plurality of commodity purchasers for the type of commodity;
retrieving, from a database, basis data for the type of commodity for each of the identified commodity purchasers, the basis data including at least a basis for each of a plurality of transaction periods;
determining distance data including a distance between the commodity seller and each of the identified commodity purchasers;
calculating a commodity price for each of the plurality of transaction periods for each of the identified commodity purchasers based on the basis data, the distance data, the storage cost, and the transportation cost; and
determining, from the identified commodity purchasers, a particular commodity purchaser with a highest commodity price.

10. The computer-readable storage media of claim 9, wherein determining the distance data includes retrieving, from a database, a driving distance between the commodity seller and each of the identified commodity purchasers, the driving distance calculated using latitude and longitude coordinates.

11. The computer-readable storage media of claim 9, the operations further comprising:
generating data used to display the commodity price for each of the plurality of transaction periods for each of the identified commodity purchasers; and
generating data used to display a difference between the highest commodity price and a commodity price for a purchaser located closest to the commodity seller.

12. The computer-readable storage media of claim 9, further comprising:
for each of the identified commodity purchasers, determining a strength of the basis associated with each transaction period; and
generating data used to display the strength of each basis.

13. The computer-readable storage media of claim 9, wherein the commodity sales data includes a location for the commodity seller chosen from a plurality of locations associated with the commodity seller and the distance data includes a distance between the chosen location and each of the identified commodity purchasers.

14. A system for determining commodity prices, the system comprising:
a purchaser database storing basis data for commodity purchasers, the basis data for each commodity purchaser including a basis for each of a plurality of commodities for each of a plurality of transaction periods;
a processor; and
a memory coupled to the processor, the memory storing instructions that, when executed by the processor, perform operations comprising:
receiving commodity sales data including a type of commodity, a storage cost per bushel for the type of commodity, and a transportation cost per bushel for the type of commodity for a commodity seller,
identifying a plurality of commodity purchasers for the type of commodity,
retrieving the basis data from the purchaser database, wherein the retrieved basis data is for the type of commodity for each of the identified commodity purchasers,
determining distance data including a distance between the commodity seller and each of the identified commodity purchasers,
calculating a commodity price for each of the plurality of transaction periods for each of the identified commodity purchasers based on the basis data, the distance data, the storage cost, and the transportation cost, and
determining, from the identified commodity purchasers, a particular commodity purchaser with a highest commodity price.

15. The system of claim 14, further comprising:
a distance database storing a driving distance between the commodity seller and each of a plurality of commodity purchasers, the driving distance calculated using latitude and longitude coordinates,
wherein determining the distance data includes retrieving, from the distance database the driving distances.

16. The system of claim 14, the operations further comprising:
generating data used to display the commodity price for each of the plurality of transaction periods for each of the identified commodity purchasers; and
generating data used to display a difference between the highest commodity price and a commodity price for a purchaser located closest to the commodity seller.

17. The system of claim 14, further comprising:
for each of the identified commodity purchasers, determining a strength of the basis associated with each transaction period; and
generating data used to display the strength of each basis.

18. The system of claim 14, wherein the commodity sales data includes a location for the commodity seller chosen from a plurality of locations associated with the commodity seller and the distance data includes a distance between the chosen location and each of the identified commodity purchasers.
